(19) United States
(12) Patent Application Publication
(10) Pub. No.: US 2008/0008495 A1
(43) Pub. Date: Jan. 10, 2008

(54) Methods for imaging cartridge conversion

(75) Inventors: Thomas J. Martin, Sanford, NC (US); Donald R. Huck, Raleigh, NC (US)

Correspondence Address: WILLIAM L. LONDON, 3010 LEE AVENUE, P.O. BOX 152, SANFORD, NC, 27330, US

(73) Assignee: Static Control Components, Inc., Sanford, NC (US)

(21) Appl. No.: 11/481,215

(22) Filed: Jul. 5, 2006

(51) Int. Cl. G03G 15/00

(52) U.S. Cl. 399/109

(57) ABSTRACT

Techniques are provided for modifying a printer cartridge intended for installation in one type of printer to be installed in another type of printer or a plurality of printers. In one aspect, a method of modifying a toner cartridge may include modifying a gear side end portion of a waste bin assembly of the toner cartridge. The altered toner cartridge is installable then installable in a different printer.

### FIELD OF INVENTION

The present invention relates to remanufacturing and modifying imaging process cartridges, such as printer toner cartridges, and more particularly to techniques for modifying an imaging process cartridge intended to operate in one type or model of imaging device, such as a printer, to operate in additional types or models of imaging devices.

### BACKGROUND

Printer cartridges are typically designed to provide the consumer a certain number of print copies before the toner or ink is exhausted. The total number of prints varies depending on the type, quality and density of the print provided by the printer. After all of the toner or ink is spent, the cartridges are either thrown away or recycled.

An emerging industry has developed that deals with the recycling of printer cartridges. Typically, the cartridge is recycled by a cartridge remanufacturer, who receives spent printer cartridges and refurbishes them. The refurbishment process entails replacing the worn or nonfunctioning parts, refilling the cartridge with either toner or ink, and distributing the refurbished cartridges into the marketplace.

Toner cartridges are typically designed to fit into one type of laser printer or family of laser printers. For example, the same toner cartridge may be used in an HP4200 or HP4300 monochrome laser printer. As new printer models are introduced, the printer manufacturer may decide to alter the physical characteristics of the printer cartridge. In some cases the alteration may be an entirely new shape or the printer manufacturer may only change a minor detail such as an indentation or a protrusion on the cartridge.

A typical toner cartridge comprises an assembled plastic housing. The material of the housing may be molded plastic or other plastic composite. During the remanufacturing of the cartridge, the cartridge is disassembled, cleaned, refurbished and reassembled. The last step of the refurbishment process typically includes refilling the cartridge with toner and repackaging of the cartridge. As part of the refurbishment process, the toner cartridges may be modified in order to remove any restriction regarding usage.

The present invention converts a printer imaging cartridge such as a laser toner cartridge for use in one type of printer to be usable in another type of printer by removing a physical structures from an end portion of the toner cartridge. The converted cartridge may then be used in other printers.

### SUMMARY

A method of modifying an imaging process cartridge, the imaging process cartridge installable in a first color imaging device and not installable in a second color imaging device, the method comprising providing the imaging process cartridge, said imaging process cartridge comprising a gear side end portion, said gear side end portion further comprising an upper hollow surfaced fin, a lower hollow surfaced fin, a solid surfaced protrusion and ribs extending between said upper and lower hollow surfaced fins and said protrusion, all mounted on a lower vertical surface, said lower vertical surface extending from a first end to a mid point of said gear side end portion, wherein said upper and lower hollow surfaced fins and said protrusion extend from said first end towards said midpoint, and removing said lower hollow surfaced fin and a section of said ribs such that a channel is created, said channel extending from said first end to said midpoint and about in between said upper hollow surfaced fin and said protrusion, said modified imaging process cartridge is installable in said second color imaging device.

A method of modifying an imaging process cartridge, the imaging process cartridge installable in a first color imaging device and not installable in a second color imaging device, the method comprising, providing the imaging process cartridge, said imaging process cartridge comprising a gear side end portion, said gear side end portion further comprising an upper hollow surfaced fin, a lower hollow surfaced fin, a solid surfaced protrusion and ribs having a first height, said ribs extending between said lower hollow surfaced fin and said protrusion, all mounted on a lower vertical surface, said lower vertical surface extending from a first end to a mid point of said gear side end portion, wherein said upper hollow surfaced fins and said protrusion extend from said first end towards said midpoint and said lower hollow surfaced fin is located at or about said midpoint and comprises a right wall a left wall and a lower wall, removing said left wall and said lower wall, and reducing in height said right wall and said protrusion such that said right wall and said protrusion are about equal to said first height, said modified imaging process cartridge is installable in said second color imaging device.

A more complete understanding of the present invention, as well as further features and advantages of the invention, will be apparent from the following detailed description and the accompanying drawings.

### BRIEF DESCRIPTION OF THE DRAWINGS

FIG. 1 shows a front perspective view of a fully assembled prior art HP3600/3800 toner cartridge.

FIG. 2 shows an exploded view of a waste bin assembly of the HP3600/3800 toner cartridge with the toner hoper removed.

FIG. 3A shows a side perspective view of a gear side end portion the waste bin assembly of the HP3600/3800 toner cartridge.

FIG. 3B shows a side view of the end portion of FIG. 3A.

FIG. 3C shows a front view of the end portion of FIG. 3A.

FIG. 4A shows a side perspective view of a modified gear side end portion of a waste bin assembly of the HP3600/3800 in accordance with one embodiment of the present invention.

FIG. 4B shows a side view of the end portion of FIG. 4A.

FIG. 4C shows a front view of the end portion of FIG. 4A.

FIG. 5A shows a side perspective view of a gear side end portion of a prior art HP3000 waste bin assembly.

FIG. 5B shows a side view of the end portion of FIG. 5A.

FIG. 5C shows a front view of the end portion of FIG. 5A.

FIG. 6A shows a side perspective view of a modified gear side end portion of a waste bin assembly of the HP3000 in accordance with one embodiment of the present invention.

FIG. 6B shows a side view of the end portion of FIG. 6A.

FIG. 6C shows a front view of the end portion of FIG. 6A.

### DETAILED DESCRIPTION

The following detailed description of preferred embodiments refers to the accompanying drawings, which illustrate specific embodiments of the invention. In the discussion that follows, specific systems and techniques for repairing, manufacturing or remanufacturing an imaging cartridge, such as a toner cartridge are used as examples. Other embodiments having different structures and operations for the repair, remanufacture and operation of other types of replaceable imaging components and for various types of imaging devices, such as laser printers, inkjet printers, copiers, facsimile machines and the like, do not depart from the scope of the present invention.

Within the printer industry, printer manufacturers have employed various techniques to differentiate between toner cartridges used in different printers. These techniques range from the obvious altering of the physical dimensions and shape of the toner cartridge or imaging drum unit to very subtle indentations or protrusions positioned at certain locations on the toner cartridge or imaging drum unit. For example, some printer manufacturers have installed protrusions such as fins or keys that extend out from the printer's toner cartridge compartment and are positioned inside a recess on the toner cartridge when the toner cartridge is installed inside the printer. In other printer types this arrangement may be reversed. The key may exist on the toner cartridge, and the recess may exist inside the toner cartridge compartment inside the printer.

As new printer models are developed, “new” toner cartridges may also be introduced. In some cases, the new toner cartridge may contain exactly the same components as those of the previous printer model. However, the new toner cartridge may have slightly different physical packaging. In some cases, the printer manufacturer may install different keys, or keys in different locations. Changing the size, shape, orientation or location of the keys allows the printer manufacturer to differentiate between a previously introduced toner cartridges and those of newer models. This may allow the printer manufacturer to increase his margins by charging the consumer a premium for the new cartridge.

Printer manufacturers may take advantage of existing toner cartridge technology by using an existing toner cartridge design and making only slight physical packaging modifications. For example, the black toner cartridge used in the HP3600 color laser printer is exactly the same cartridge used in the HP3800 color laser printer. The other HP3600 color toner cartridges are physically identical to the HP3800 color toner cartridges with the exception of an electronic identification chip. Even though the cartridges fit interchangeably in either printer, an error message may be displayed by the printer if an HP3600 cyan toner cartridge is installed in an HP3800 color laser printer.

In subsequent sections, the present invention is discussed with reference to the HP3600 toner cartridge as an illustrative example. However, since the HP3600 cartridges and the HP3800 cartridges are physically identical, it is intended that the inventive concepts as explained as they relate to the HP3600 cartridges also apply to the HP3800 toner cartridges as well.

The HP3600 toner cartridges may have exactly the same internal components and even use the same toner as the toner cartridges used in the HP3000 color laser printer. The two cartridge types may be quite similar physically. The only physical differentiating feature between the two styles of cartridges is the keys and their locations on an end portion of their respective waste bin assemblies.

In the toner cartridge refurbishment industry, the used toner cartridges are collected and serviced by toner cartridge remanufacturers. The first step in the refurbishment process is the disassembling of the spent cartridges. Next, the internal components are separated. Non-functioning components are replaced, and the remaining components, as well as the body of the device undergo a cleaning process. In the final step the device is reassembled and new toner is added to the toner cartridge. The refurbished device is then packaged and distributed to the consumer.

Part of the refurbishment process may include making physical alterations to the toner cartridge. For example, older cartridges may be altered or converted for use in other printer types. Alternatively, the remanufacturer may remove all of the physical restrictions from the toner cartridge, thus creating a “universal” cartridge that may be used in across multiple printers. The present invention provides a way of converting a printer toner cartridge for use one type of printer to be useable in another type of printer.

As is discussed in greater detail in subsequent sections, a toner cartridge used in the HP3600 color laser printer is not physically compatible in the HP3000 color laser printer due to keying differences between the cartridges. Similarly, toner cartridges used in the HP3000 color laser printer are not compatible for use in the HP3600 color laser printer.

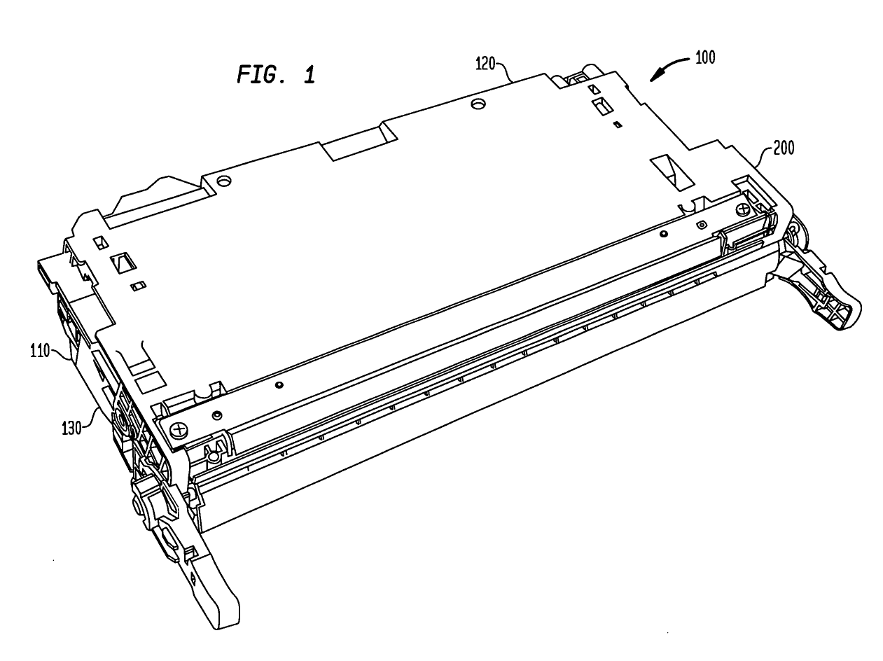

FIG. 1 shows a front perspective view of a prior art toner cartridge 100 used in the HP3600 color laser printer. The cartridge 100 may be installed in any of the toner cartridge locations within the HP3600 color laser printer (black, cyan, magenta or yellow), depending on the color of toner contained in the cartridge 100. Cartridge 100 comprises a toner hopper assembly 110 and a waste bin assembly 120. On the ends of the cartridge 100 are a gear side end portion 200 as well as a contact side end portion 130. During the remanufacturing process, the hopper assembly 110 and the waste bin assembly 120 are separated.

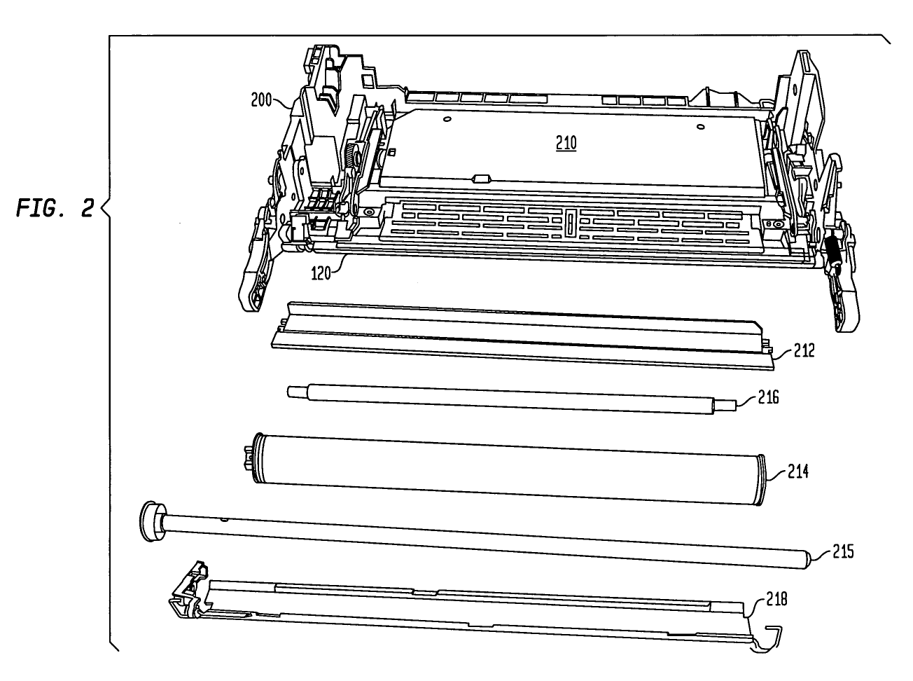

FIG. 2 displays a front perspective exploded view of the waste bin assembly 120 with the toner hopper assembly 110 removed. The waste bin assembly 120 comprises a wiper blade 212 that removes any excess toner off of the OPC (Organic Photo Conductor) drum 214 into the waste bin 210 during the printing process. A drum shaft 215 is inserted into the OPC drum 214 allowing the OPC drum 214 to rotate. A PCR 216 (Primary Charge Roller) provides the OPC drum 214 with a uniform charge. Protecting the OPC drum 214 and other internal components is a drum shutter 218. Those skilled in the art appreciate that during the laser printing process, the printer applies a laser which statically charges the OPC drum 214 with an appropriate charge corresponding to the image the printer is printing. The OPC drum 214 then collects toner from the toner hopper 110 which is then applied to the print media. After the toner is transferred to the printing media, the toner is fused onto the print media by a fuser assembly (not shown).

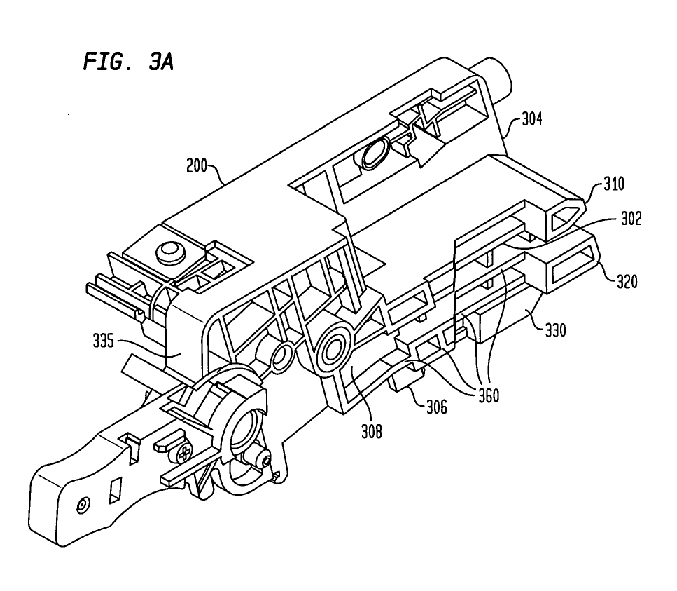

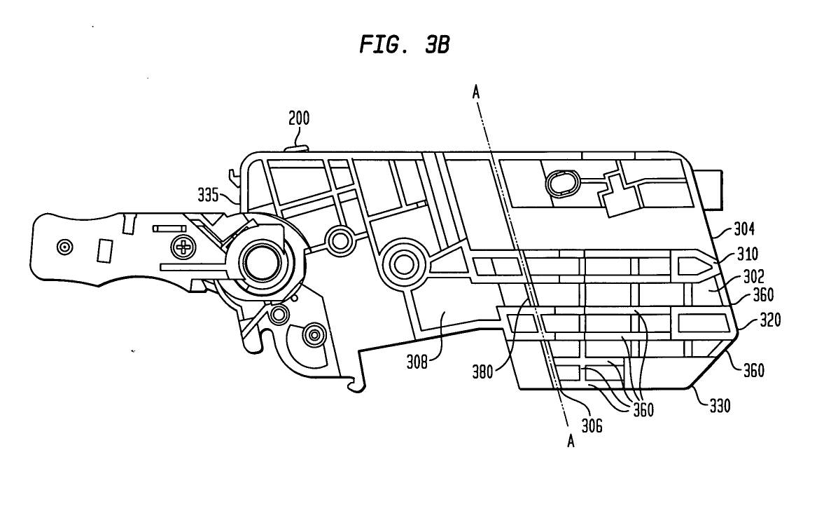

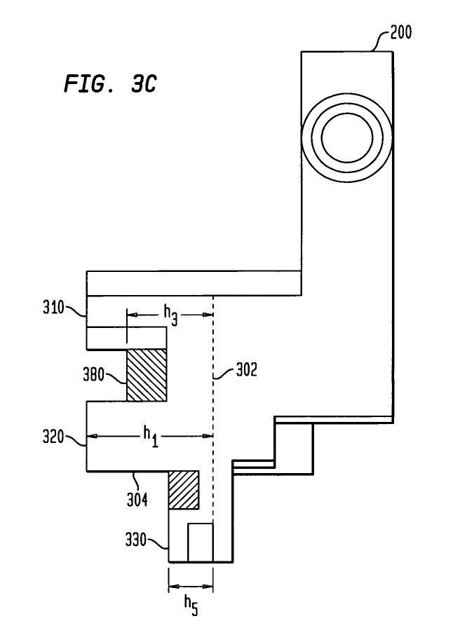

The HP3600 color toner cartridges are not compatible in the HP3000 color laser printers due to physical differences in the waste bin assembly gear side end portion 200. FIG. 3A displays a side perspective view of the waste bin assembly gear side end portion 200 for the HP3600 color laser printer. During the typical refurbishment process, the waste bin assembly gear side end portion 200 is not removed from the cartridge 100 because the gear side end portion 200 is molded together with the waste bin assembly 120. In the supporting figures the gear side end portion 200 is shown separated merely for illustrative purposes.

As can be seen in FIG. 3A, the gear side end portion 200 has an upper hollow surfaced fin 310 and a lower hollow surfaced fin 320 located at a first end 304 of a first lower vertical surface 302. FIG. 3B displays a side view of the gear side end portion 200 and FIG. 3C shows a cut away front view of the gear side end portion 200 with the gear side end portion 200 cut at the axis A-A.

The upper and lower hollow surfaced fins 310, 320 extend perpendicularly away from the lower vertical surface 302 (shown as a dashed line in FIG. 3C) and are about the same height h₁. The two hollow surfaced fins 310, 320 align with corresponding recesses located in the printer cartridge location within the HP3600 color laser printer. Typically, the height h₁ is about ½″ (1.3 cm).

The lower vertical surface 302 extends laterally from the first end 304 to about a mid point 306 of the gear side end portion 200. Mounted on the lower vertical surface 302 below the lower hollow surfaced fin 320 is a solid surfaced protrusion 330 which extends a height h₂ above the lower surface 302. In the embodiment shown in FIG. 3C, the height is typically 0.2″ (4.7 mm)

Extending from about the midpoint 306 away from the first end 304 towards a second end 335 is an upper vertical surface 308. Latticed all throughout the lower vertical surface 302 and part of the upper vertical surface 308 are ribs 360. The ribs 360 connect the upper and lower hollow surfaced fins 310, 320, and the solid surfaced protrusion 330. The height of the ribs 360 varies. The ribs 360 located at or about the mid point 306 are roughly the same height h₁ as lower hollow surfaced fin 320. However, there is one fin 380 at the midpoint 306, parallel to axis A-A, which is between the upper hollow surfaced fin 310 and the lower hollow surfaced fin 320 that has a height h₃ (about 0.3″ or 7.6 mm) and is shown as shaded in FIG. 3C. Ribs 360 near the upper and lower hollow surfaced fins 310, 320 protrude about a 0.2″ (4.7 mm) away from the lower vertical surface 302.

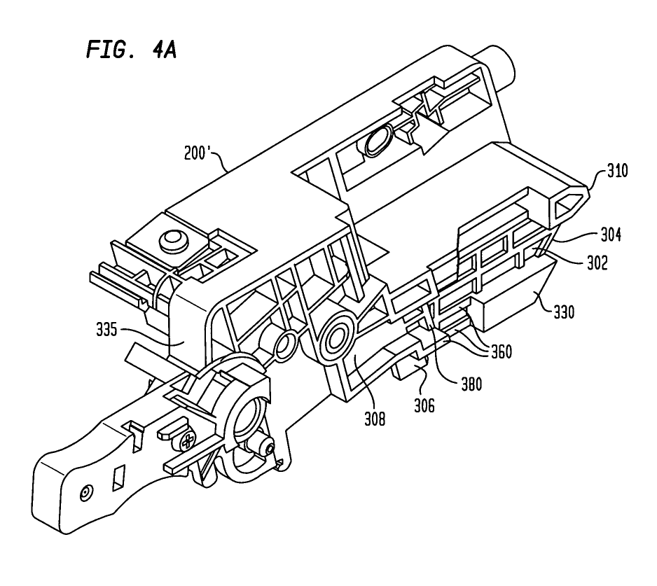

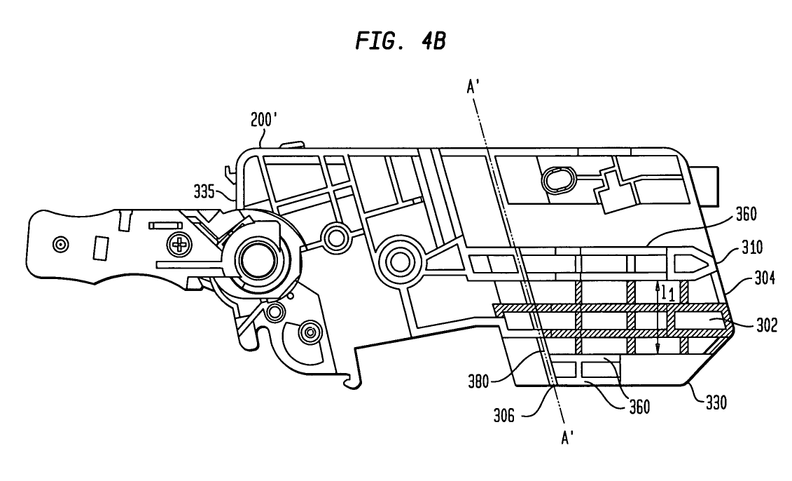

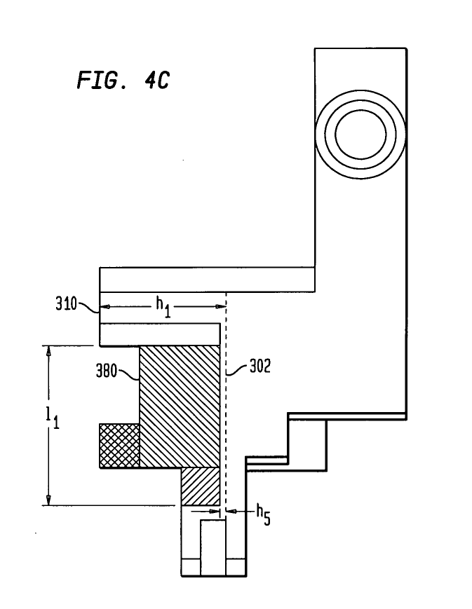

Altering an image process cartridge having the characteristics of toner cartridges used in the HP3600 color laser printer to allow it to fit in an HP3000 color laser printer requires altering the physical characteristics of the gear side end portion 200. FIGS. 4A-C display views of an altered gear side end portion 200′ in accordance with one embodiment of the present invention. As can be seen in the side perspective view of FIG. 4A, the lower hollow surfaced fin 320 has been removed. In addition, the ribs 360 between the upper hollow surfaced fin 310 and the solid surfaced protrusion 330 have been reduced in height to a height h₅. A channel of length l₁ extends between the upper hollow surfaced fin 310 and the solid surfaced protrusion 330 from the first end 304 through a portion of the upper vertical surface 308. The shaded structures as displayed in FIG. 4B show where the physical modifications are made.

As shown in the embodiment of FIG. 4C, the modified ribs are reduced in size. The height h₅ of the modified ribs and lower hollow surfaced fin 320 may protrude about less than 0.1″ or 2.54 mm above the lower vertical surface 302. In another embodiment, the modified lower hollow surfaced fin 320 and ribs may be removed completely, with nothing protruding away from the lower vertical surface 302.

One way to modify the gear side end portion 200 is to use a hack saw, file, band saw, jig saw, Rotozip™, Dremmel™ or other similar tool. Although not recommended, the channel may be created by melting ribs and the lower hollow surfaced fin 320. Once the channel has been created, a file or other type of tool may be used in order to smooth out any rough surfaces left over from the modification process.

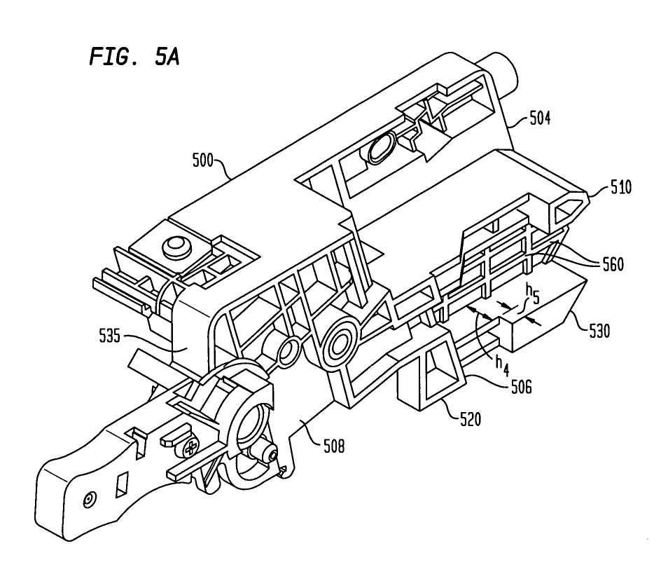

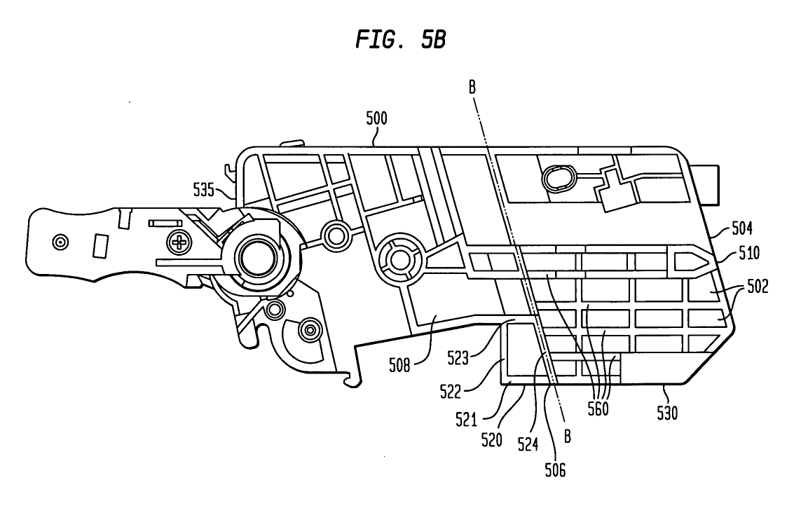

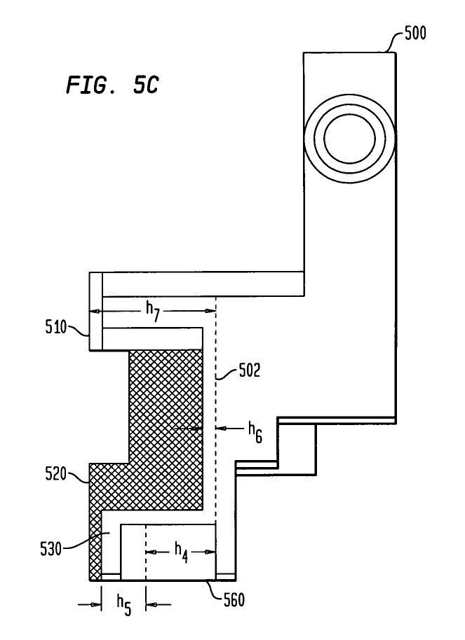

In yet another embodiment, an HP3000 toner cartridge is modified in order to allow it to fit in an HP3600 color laser printer. As mentioned previously, the gear side end portions of the two cartridges are slightly different. FIGS. 5A-C display an unaltered gear side end portion 500 of an HP3000 toner cartridge. The front view of FIG. 5C shows a cutaway view of the gear side end portion 500 as cut away on axis B-B (FIG. 5B) which is about at a midpoint 506.

As can be seen in FIGS. 5A-C, the gear side end portion 500 is similar to the gear side end portion 200 of FIGS. 3A-C. Gear side end portion 500 has an upper hollow surfaced fin 510 protruding away from a lower vertical surface 502, extending from a first edge 504 towards the midpoint 506. The gear side end portion 500 also has a lower hollow surfaced fin 520 that has a lower side 521, a left side 522, an upper side 523 and a right side 524. The location of lower hollow surfaced fin 520 is different than lower hollow surfaced fin 320. Lower hollow surfaced fin 520 is still below the upper hollow surfaced fin 510 and mounted on lower vertical surface 502, but it is located at or near the midpoint 506. The height h₇ of the lower hollow surfaced fin 520 is about equal to the height of the upper hollow surfaced fin 510, which is about ½″ (12.7 mm).

Mounted on the lower vertical surface 502, at first edge 504 and below the upper hollow surfaced fin 510 is also solid surfaced protrusion 530. Latticed between the upper hollow surfaced fin 510 and the solid surfaced protrusion 530 are ribs 560 extending away from the lower vertical surface 502. The ribs vary in height with some ribs having a height about equal to the height of the upper hollow surfaced protrusion h₇. Below the upper hollow surfaced fin 510 the ribs have a height h₆ of about 0.1″ (2.5 mm). Those ribs parallel with the solid surfaced protrusion 530 have a height h₄ of about 0.3″ (7.6 mm).

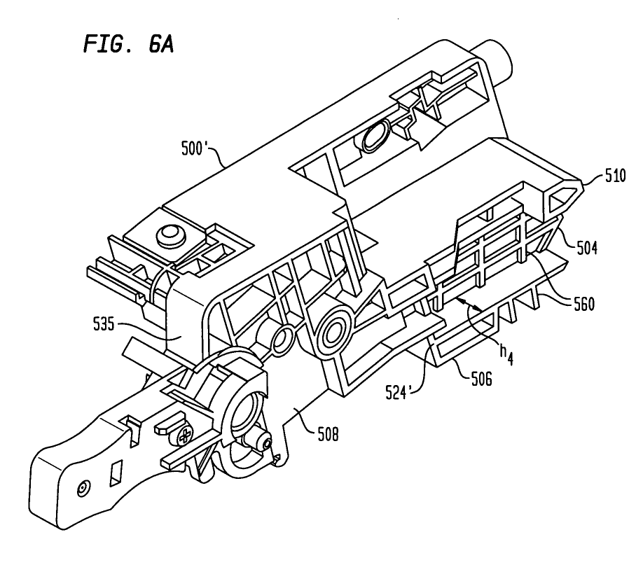

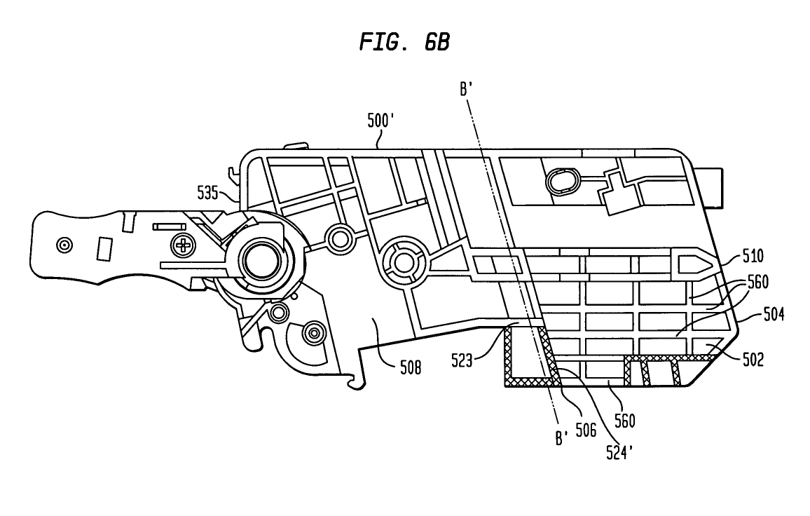

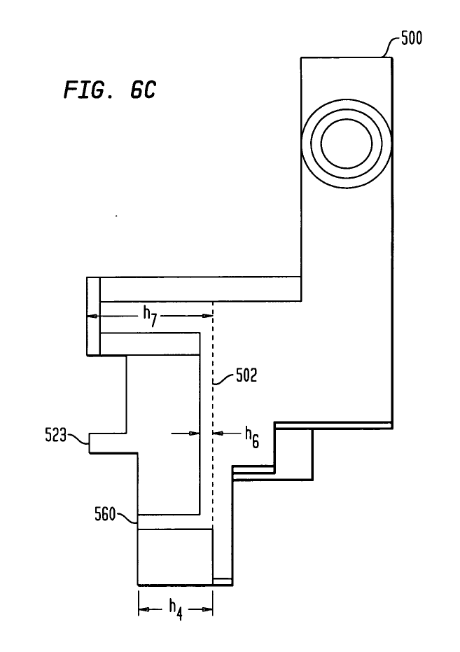

In accordance with another embodiment of the present invention, the gear side end portion 500 may be modified to allow the modified toner cartridge to be able to fit inside an HP3600 color laser printer. A modified gear side portion 500′ is displayed in FIGS. 6A-C. The first step in converting the gear side end portion 500 includes reducing the height of the solid surfaced protrusion shown as shaded areas of FIG. 6B. The altered protrusion has a height about or equal to the height h₄ of the adjacent ribs 560 (FIG. 6C)

In addition to removing a section of the solid surfaced protrusion 530, most of the lower hollow surfaced fin 520 is also removed. As shown in FIG. 6B, the lower wall 521 and the left wall 522 are completely removed. The modified right wall 524′ has a height of h₄ and no modifications are performed on the upper wall 523.

As previously discussed, the modifications to the gear side end portion 500 may involve using a hack saw, band saw, jig saw, Rotozip™, Dremmel™ or other similar tool. Although not recommended, the modifications may be accomplished by melting the associated structures.

Within the toner cartridge, an electronic identification chip may be installed. The identification chip may contain information relating to the printer type, printer manufacturer, amount of toner contained in the toner cartridge and so forth. Even if the physical restrictions between cartridge types have been removed, the electronic identification chip may need to be replaced with a compatible electronic chip in order to allow the altered toner cartridge to function properly in its new location or printer.

Although specific embodiments have been illustrated and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of modifying an imaging process cartridge, the imaging process cartridge installable in a first color imaging device and not installable in a second color imaging device, the method comprising:
providing the imaging process cartridge, said imaging process cartridge comprising a gear side end portion, said gear side end portion further comprising an upper hollow surfaced fin, a lower hollow surfaced fin, a solid surfaced protrusion and ribs extending between said upper and lower hollow surfaced fins and said protrusion, all mounted on a lower vertical surface, said lower vertical surface extending from a first end to a mid point of said gear side end portion, wherein said upper and lower hollow surfaced fins and said protrusion extend from said first end towards said midpoint;
removing said lower hollow surfaced fin and a section of said ribs such that a channel is created, said channel extending from said first end to said midpoint and about in between said upper hollow surfaced fin and said protrusion, said modified imaging process cartridge is installable in said second color imaging device.

2. The method of claim 1 wherein said modified process cartridge is installable in an HP3000 color laser printer.

3. A method of modifying an imaging process cartridge, the imaging process cartridge installable in a first color imaging device and not installable in a second color imaging device, the method comprising:
providing the imaging process cartridge, said imaging process cartridge comprising a gear side end portion, said gear side end portion further comprising an upper hollow surfaced fin, a lower hollow surfaced fin, a solid surfaced protrusion and ribs having a first height, said ribs extending between said lower hollow surfaced fin and said protrusion, all mounted on a lower vertical surface, said lower vertical surface extending from a first end to a mid point of said gear side end portion, wherein said upper hollow surfaced fins and said protrusion extend from said first end towards said midpoint and said lower hollow surfaced fin is located at or about said midpoint and comprises a right wall a left wall and a lower wall;
removing said left wall and said lower wall;
reducing in height said right wall and said protrusion such that said right wall and said protrusion are about equal to said first height, said modified imaging process cartridge is installable in said second color imaging device.

4. The method of claim 3 wherein said modified process cartridge is installable in an HP 3600 color laser printer
